(19) United States
(12) Patent Application Publication
(10) Pub. No.: US 2022/0108221 A1
(43) Pub. Date: Apr. 7, 2022

(54) Systems And Methods For Parameter Sharing To Reduce Computational Costs Of Training Machine-Learned Models

(71) Applicant: Google LLC, Mountain View, CA (US)

(72) Inventors: Dengyong Zhou, Redmond, WA (US); Xiaodan Song, Cupertino, CA (US); Shuo Yang, Austin, TX (US); Qiang Liu, Austin, TX (US); Le Hou, South Setauket, NY (US)

(21) Appl. No.: 17/493,442

(22) Filed: Oct. 4, 2021

Related U.S. Application Data
(60) Provisional application No. 63/087,017, filed on Oct. 2, 2020.

(51) Int. Cl. G06N 20/00

(52) U.S. Cl. CPC G06N 20/00

(57) ABSTRACT

Systems and methods of the present disclosure are directed to a computer-implemented method. The method can include obtaining a machine-learned model comprising a plurality of model units, wherein each model unit comprises a plurality of parameters that are tied to a shared plurality of parameters. The method can include performing a first plurality of training iterations with the machine-learned model to adjust parameters of the shared plurality of parameters. The method can include detecting, based on the first plurality of training iterations, an occurrence of an untying condition. The method can include untying the parameters of one or more model units from the shared plurality of parameters. The method can include performing a second plurality of training iterations with the machine-learned model to adjust parameters of the one or more model units independent of the shared plurality of parameters.

### RELATED APPLICATIONS

This application claims priority to and the benefit of U.S. Provisional Patent Application No. 63/087,017, filed Oct. 2, 2020. U.S. Provisional Patent Application No. 63/087,017 is hereby incorporated by reference in its entirety.

### FIELD

The present disclosure relates generally to training machine-learned models via parameter sharing. More particularly, the present disclosure relates to parameter sharing between similar units of a machine-learned model to reduce computational costs during training.

### BACKGROUND

Generally, increasing the size of a machine-learned model can lead to significant performance improvements in a variety of machine-learning tasks (e.g., natural language processing, computer vision, statistical analysis, etc.). However, increasing the size of a model can also lead to corresponding increases in computational costs and training time.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for reducing computational costs of training a machine-learned model. The method can include obtaining, by a computing system comprising one or more computing devices, a machine-learned model comprising a plurality of model units, wherein each of the plurality of model units comprise a plurality of parameters that are tied to a shared plurality of parameters. The method can include performing, by the computing system, a first plurality of training iterations with the machine-learned model to adjust one or more parameters of the shared plurality of parameters. The method can include detecting, by the computing system based at least in part on at least one of the first plurality of training iterations, an occurrence of an untying condition. The method can include untying, by the computing system, the plurality of parameters of one or more model units from the shared plurality of parameters. The method can include performing, by the computing system, a second plurality of training iterations with the machine-learned model to adjust one or more parameters of each of the one or more model units.

Another example aspect of the present disclosure is directed to a computing system for reducing computational costs of training a machine-learned model. The computing system can include one or more processors. The computing system can include one or more tangible, non-transitory computer readable media storing computer-readable instructions that when executed by the one or more processors cause the one or more processors to perform operations. The operations can include obtaining a machine-learned model comprising a plurality of model units, wherein each of the plurality of model units comprise a plurality of parameters that are tied to a shared plurality of parameters. The operations can include performing a first plurality of training iterations with the machine-learned model to adjust one or more parameters of the shared plurality of parameters. The operations can include detecting, based at least in part on at least one of the first plurality of training iterations, an occurrence of an untying condition. The operations can include untying the plurality of parameters of one or more model units from the shared plurality of parameters. The operations can include performing a second plurality of training iterations with the machine-learned model to adjust one or more parameters of each of the one or more model units.

Another example aspect of the present disclosure is directed to one or more tangible, non-transitory computer readable media storing computer-readable instructions that when executed by one or more processors cause the one or more processors to perform operations. The operations can include obtaining a machine-learned model comprising a plurality of model units, wherein each of the plurality of model units comprise a plurality of parameters that are tied to a shared plurality of parameters. The operations can include performing a first plurality of training iterations with the machine-learned model to adjust one or more parameters of the shared plurality of parameters. The operations can include detecting, based at least in part on at least one of the first plurality of training iterations, an occurrence of an untying condition. The operations can include untying the plurality of parameters of one or more model units from the shared plurality of parameters. The operations can include performing a second plurality of training iterations with the machine-learned model to adjust one or more parameters of each of the one or more model units.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs shared parameter training of a machine-learned model according to example embodiments of the present disclosure.

FIG. 1B depicts a block diagram of an example computing device that utilizes a machine-learned model partially trained using weight sharing according to example embodiments of the present disclosure.

FIG. 1C depicts a block diagram of an example computing device that performs shared parameter training of a machine-learned model according to example embodiments of the present disclosure.

FIG. 2 depicts a block diagram of an example model partially trained using weight sharing according to example embodiments of the present disclosure.

FIG. 3 depicts a flow diagram of an example method for training of a machine-learned model using partial weight sharing according to example embodiments of the present disclosure.

FIG. 4 depicts a flow chart diagram of an example method to perform training of a machine-learned model using partial weight sharing according to example embodiments of the present disclosure.

Reference numerals that are repeated across plural figures are intended to identify the same features in various implementations.

### DETAILED DESCRIPTION

### Overview

Generally, the present disclosure is directed to training machine-learned models via parameter sharing. More particularly, the present disclosure relates to parameter sharing between similar units of a machine-learned model to reduce computational costs during training. As an example, a machine-learned model can be obtained that includes a plurality of model units (e.g., a sequence of deep learning layers, etc.). Each of the model units can include a plurality of parameters (e.g., weights, biases, etc.). Further, the parameters of each model unit can be tied to a shared plurality of parameters. A first plurality of training iterations can be performed with the machine-learned model. Based on the first plurality of training iterations, one or more parameters of the shared plurality of parameters can be adjusted, therefore adjusting one or more parameters of each model unit tied to the shared parameters in the same manner. Based on at least one of the first training iteration, the occurrence of an untying condition can be detected (e.g., a number of completed iterations, a correlation between shared parameters, an evaluation of gradient statistics, etc.), and one or more of the model units can be untied from the shared plurality of parameters. A second plurality of training iterations can then be performed to train the parameters of the one or more untied model units and/or the shared parameters. In such fashion, the parameters of multiple model units can be shared during a plurality of training iterations, therefore providing a significant reduction in the computational costs associated with training each of the model units individually.

More particularly, a computing system can obtain a machine-learned model that includes a plurality of model units. Each of the model units can include a plurality of parameters that are tied to a shared plurality of parameters. As an example, the machine-learned model can be a deep learning network, which can be obtained by repeatedly stacking the same model unit n times (e.g., the transformer module in transformer models, etc.). The plurality of parameters of each of the model units n can be denoted as w₁, . . . , wₙ (e.g., the parameters (weights) of the n units).

A first plurality of training iterations can be performed with the machine-learned model to adjust one or more parameters of the shared plurality of parameters (e.g., the parameters shared between the model units, etc.). Based at least in part on at least one of the first plurality of training iterations, an occurrence of an untying condition can be detected. More particularly, the deep network can first be trained with the shared plurality of parameters (e.g., weights, etc.) tied. Then, after the occurrence of the untying condition (e.g., occurrence of a certain number of training steps, etc.), the parameters (e.g., weights) can be untied, and the network can be further trained until convergence. In some implementations, the untying condition can be predefined (e.g., as a hyperparameter, etc.). Additionally, or alternatively, in some implementations the untying condition can be or adaptively determined.

After detection of the occurrence of the untying condition, a plurality of parameters of one or more of the model units can be untied from the shared parameters. In some implementations, the untying condition can be an adaptive condition. As an example, for every certain number of training iterations, a correlation between the gradients of any two model units can be checked. If more than half of these unit correlations are less than a predefined threshold p (0.5 as default) consecutively for a certain number of times, the model units can be untied from the shared plurality of parameters.

After untying the plurality of parameters of the one or more model units, a second plurality of training iterations can be performed with the machine-learned model. Based on the training iterations, parameter(s) of each of the one or more model units can be adjusted independently of the shared plurality of parameters. More particularly, the weights of the untied model unit(s) can be trained individually, while any other untied model units can be trained based on the shared plurality of parameters. In such fashion, model units of the machine-learned model can be trained using shared parameters for a certain number of iterations, and can then be trained independently.

Thus, some example implementations assume that there is a deep network which is obtained by repeatedly stacking the same neural units times, such as the transformer module in transformer models. Denote by w₁, . . . , wₙ the weights of these n units. In some example implementations of the proposed method, a training system first trains the deep network with all the weights tied. Then, after a certain number of training steps, the training system unties the weights and further trains the network until convergence. The untying point can be predefined or adaptively determined.

In some examples, weight sharing is stopped at a fixed point. Below is an example algorithm (Algorithm 1) that stops weight sharing at a fixed point.

As an example, the sharing of parameters between the model units can be performed in the following manner:

Algorithm 1: Fixed Point:

| | |
|---|---|
| 1. | Input: total number of training steps T , untying point τ, learning rates |
| | {α^{(t)} , t = 1, ... , T} |
| 2. | Randomly and equally initialize weights w₁⁽⁰⁾, ... , wₙ⁽⁰⁾ |
| 3. | for t = 1 to T t < τ do: |

| | |
|---|---|
| 4. | If t < T then |

| | |
|---|---|
| 5. | wᵢ^{(t)} = w₁^{(t-1)} − α^{(t)} × mean{grad(loss, wₖ^{(t-1)}), k = 1, ... , |

n}, i = 1, ... , n

| | |
|---|---|
| 6. | else |

| | |
|---|---|
| 7. | wᵢ^{(t)} = w₁^{(t-1)} − α^{(t)} × grad(loss, wᵢ^{(t-1)}), i = 1, ... , n |

Note that, from line 1 to 5, the example Algorithm 1 initializes all the weights equally, and then updates them using the mean of their gradients. It is easy to see that such an update is equivalent to weight sharing or tying. For the sake of simplicity, in line 5 and 7, the example algorithm shows how to update the weights using the plain (stochastic) gradient descent rule. One can replace this plain update rule with any of their favorite optimization methods, for example, the Adam optimization algorithm or any others.

While the repeated layers are the most natural units for weight sharing, that is not the only choice. In some implementations, several layers together may be viewed as the weight sharing unit, and weights can be shared across those units. The layers within the same unit can have different weights. For example, for a 24-layer transformer model, one example may combine every four layers as a weight sharing unit. Thus, there will be six such units for weight sharing. Such a flexibility of choosing weight sharing units allows for a balance between “full weight sharing” and “no weight sharing” at all.

In some example implementations, weight sharing can be stopped at an adaptive point. For example, instead of setting up a fixed point τ in Algorithm 1, other example implementations can determine when to stop sharing weights using gradient statistics. A simple heuristics is as follows. For every certain number of iteration steps, a computing system can check the correlation between the gradients of any two adjacent layers. If more than half of these layer correlations are less than a predefined threshold ρ (e.g., 0.5 as default) consecutively for a certain number of times, the computing system can stop sharing weights.

Thus, the present disclosure offers an example heuristic method that shares the weight and unties them adaptively. It only requires 3 scalar parameters to fully specify the untying strategy: ρ is the correlation threshold, τ_{check} is the period of checking correlation and M is the tolerance. The algorithm will check gradient correlation every τ_{check} steps, if the weight shared layers' gradients correlation falls below ρ for M consecutive times, it can trigger the untying between those layers.

Specifically, an example algorithm starts off by initializing and sharing weights across all shareable weights. It will monitor the adjacent layers' gradient correlation during the training. Once the gradient correlation between layers i, i+1 falls below the threshold defined by {ρ, τ_{check}, M} above, the weight sharing is untied at layer i (i.e. the weight sharing group changes from {0,1, . . . , L} to {0,1, . . . , i}, {i+1, i+2, . . . , L}). process will continue until all the layers are untied or it reaches the end of training.

In some example implementations, weight sharing can be stopped with multiple steps. Example implementations can gradually untie weights instead of untying them all the once (see, e.g., Algorithm 2). To implement this idea, the layers can be distributed into different groups. The layers in the same group share weights, while the layers in different groups can have different weights.

As training progresses, a computing system can check if any group meets a splitting criterion. Once it does, that group can be split into two, and the computing system can continue training in each subgroup. This process can be repeated until all layers are untied or the end of training is reached. At the beginning, in some example implementations, all layers can be put into the same group. One example splitting criterion is like the above heuristics of adaptive weight untying. Assume we have a group of L layers, denoted by {1, . . . , L}. A computing system can compute the correlation between the gradients of any two adjacent layers. Once the correlation between layers i, i+1 falls below a predefined threshold, the computing system can split the group into two subgroups: {1, . . . , i} and {i+1, i+2, . . . , L}. Other splitting criterion can be used as well, such as, for example, a fixed splitting point.

Algorithm 2: Unsharing Over Multiple Steps

| | |
|---|---|
| 1. | Input: total number of training steps T, learning rates {α^{(t)}, t = 1, ... , |
| | T} |
| 2. | Group layers, and randomly and equally initialize weights |
| 3. | For t = 1 to T do |

| | |
|---|---|
| 4. | Split the groups which meet the splitting criterion |
| 5. | Update the weights in each group using the gradient mean |

In some implementations, the proposed training techniques can be provided as a cloud service available to various users of a cloud-based machine learned training platform. For example, a user can supply or otherwise identify a set of clean and/or augmented training examples. The processes described herein can then be performed to automatically train models using partial weight sharing with training data identified by the user or generated by the user. For example, the model training can be performed as a service. he trained model can be provided as an output to the user (e.g., automatically deployed on behalf of or to one or more devices associated with the user).

The present disclosure provides a number of technical effects and benefits. As one example technical effect and benefit, the systems and methods of the present disclosure enable shared parameter training for units of a machine-learned model (e.g., layers, modules, etc.). As the size of machine-learned models (and therefore performance) increases, the computational costs and training times for such models also increase. As such, the ability to train a single shared set of parameters for a number of training iterations drastically reduces the time required to train the model, therefore leading to substantial reductions in the computational costs and inefficiencies (e.g., power, memory, storage, processing time, resource utilization, etc.) associated with training a model.

With reference now to the Figures, example embodiments of the present disclosure will be discussed in further detail.

### Example Devices and Systems

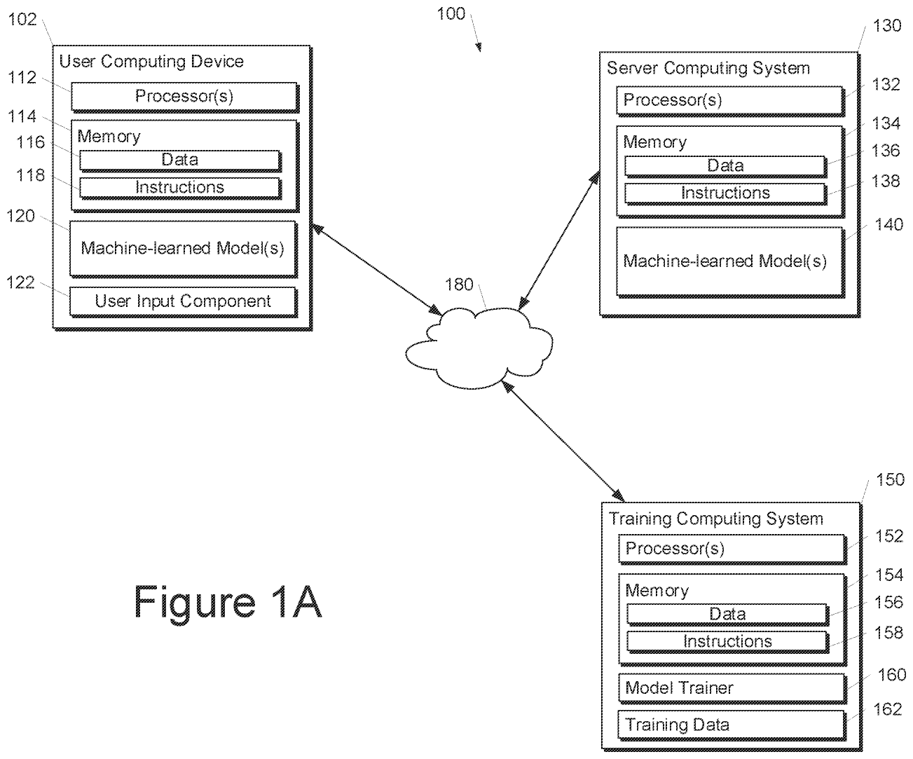

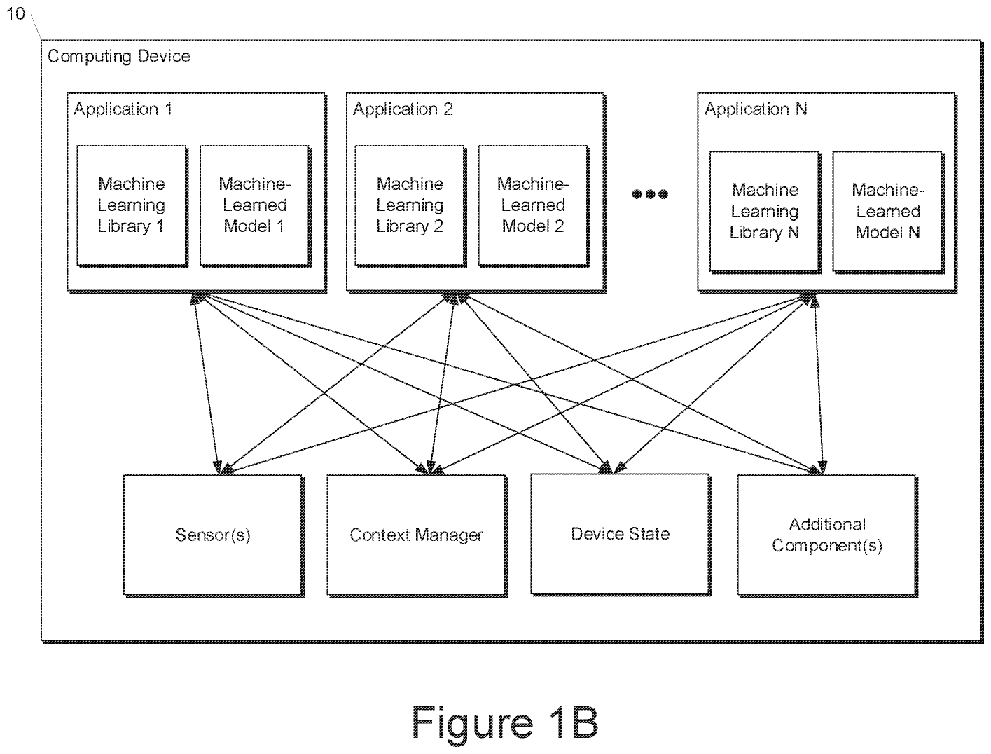

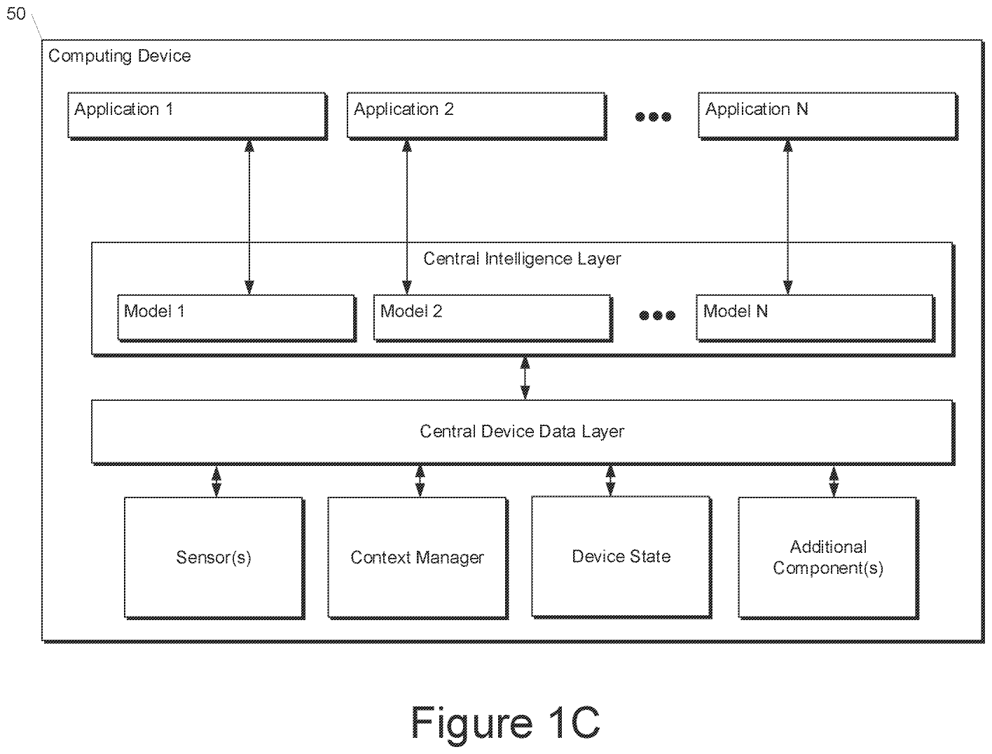

FIG. 1A depicts a block diagram of an example computing system 100 that performs shared parameter training of a machine-learned model according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

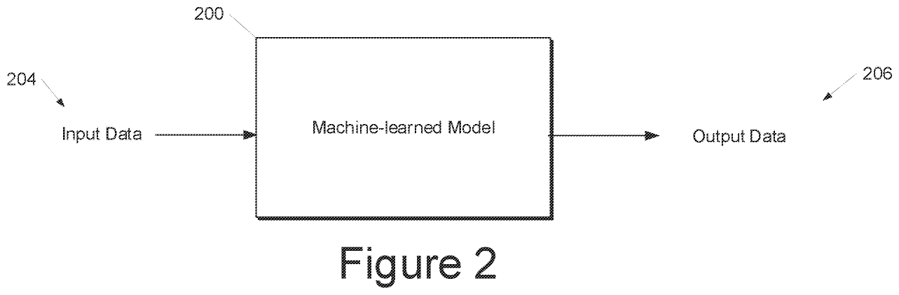

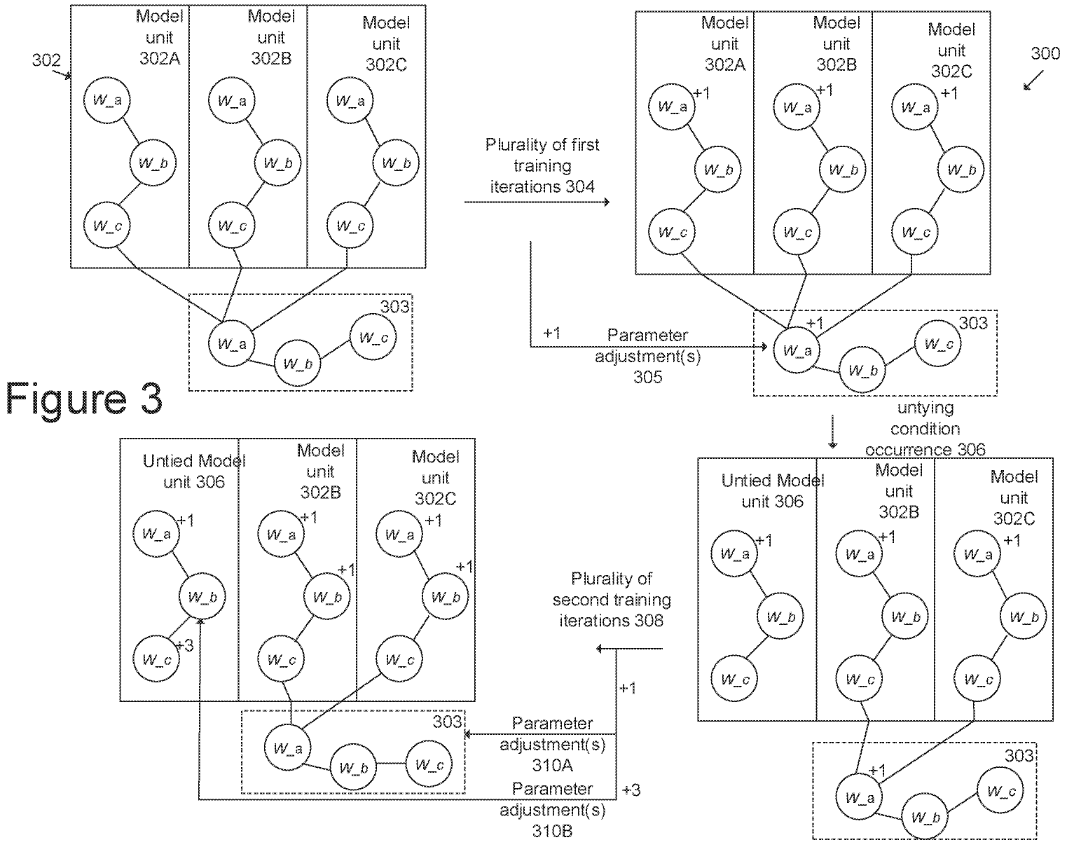

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example models 120 are discussed with reference to FIGS. 2-3.

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel machine-learned processing across multiple instances of the model).

Additionally, or alternatively, one or more models 140 can be included in or otherwise stored and implemented by the server computing system 130 that communicates with the user computing device 102 according to a client-server relationship. For example, the OVERALL models 140 can be implemented by the server computing system 140 as a portion of a web service (e.g., a machine-learned processing service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

More particularly, the training computing system 150 can train the model(s) 120 and/or 140 using parameter sharing between similar units of a machine-learned model to reduce computational costs during training. As an example, machine-learned model 120/140 can be obtained by the training computing system 150 that includes a plurality of model units (e.g., a sequence of deep learning layers, etc.). Each of the model units can include a plurality of parameters (e.g., weights, biases, etc.). Further, the parameters of each model unit can be tied to a shared plurality of parameters. A first plurality of training iterations can be performed with the machine-learned model 120/140 by the model trainer 160. Based on the first plurality of training iterations, one or more parameters of the shared plurality of parameters can be adjusted by the model trainer 160, therefore adjusting one or more parameters of each model unit tied to the shared parameters in the same manner. Based on at least one of the first training iteration, the occurrence of an untying condition can be detected by the model trainer 160 (e.g., a number of completed iterations, a correlation between shared parameters, an evaluation of gradient statistics, etc.), and one or more of the model units can be untied from the shared plurality of parameters. A second plurality of training iterations can then be performed by the model trainer 160 to train the parameters of the one or more untied model units and/or the shared parameters of the models 120/140. In such fashion, the parameters of multiple model units can be shared during a plurality of training iterations, therefore providing a significant reduction in the computational costs associated with training each model 120/140.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may comprise compressed audio data. In another example, the input includes visual data (e.g. one or more image or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that utilizes a machine-learned model partially trained using weight sharing according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs shared parameter training of a machine-learned model according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example model 200 partially trained using weight sharing according to example embodiments of the present disclosure. In some implementations, the model 200 is trained to receive a set of input data 204 descriptive of any sort of input (e.g., image, audio, statistical, video, etc.) and, as a result of receipt of the input data 204, provide output data 206.

FIG. 3 depicts a flow diagram of an example method 300 for training of a machine-learned model 302 according to example embodiments of the present disclosure. More particularly, a machine-learned model 302 can be obtained that includes a plurality of model units 302A-302C (e.g., a sequence of deep learning layers, etc.). Each of the model units can include a plurality of parameters (e.g., w_a, w_b, w_c, etc.). Further, the parameters of each model unit can be tied to a shared plurality of parameters 303. A first plurality of training iterations 304 can be performed with the machine-learned model 302. Based on the first plurality of training iterations 304, one or more parameters of the shared plurality of parameters 302 can be adjusted via parameters adjustment(s) 305.

As depicted, by applying parameter adjustment(s) 305 to the shared parameters 303, the parameters of each of the model units 302A-302C are also adjusted in the same manner, as they are tied to the shared parameters 303. Next, based on at least one of the first training iterations 304, the occurrence of an untying condition 306 can be detected (e.g., a number of completed iterations, a correlation between shared parameters, an evaluation of gradient statistics, etc.), and one or more of the model units 302A-302C can be untied from the shared plurality of parameters 303. As depicted, the model unit 302A can be untied from the shared parameters 303 to become an untied model unit 306.

A second plurality of training iterations 308 can then be performed to train the parameters of the one or more untied model unit 306 and/or the shared parameters 303. As demonstrated, parameter adjustment(s) 310A can be applied to the shared parameters 303, and parameter adjustment(s) 310B can be applied to the untied model unit 306 independently from the shared parameters 303. In such fashion, the parameters of multiple model units 302A-C can be shared during a plurality of training iterations, therefore providing a significant reduction in the computational costs associated with training each of the model units 302A-C individually.

### Example Methods

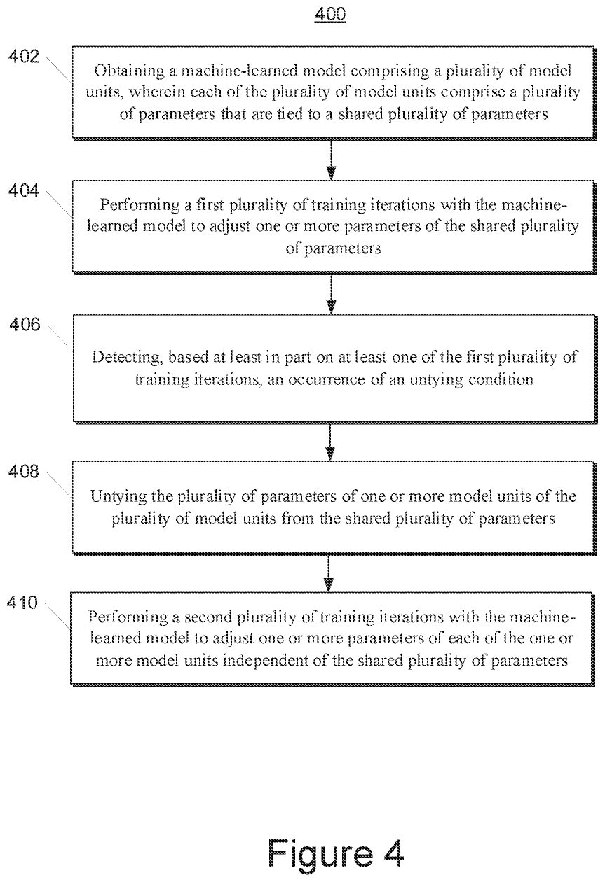

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can obtain a machine-learned model comprising a plurality of model units, wherein each of the plurality of model units comprise a plurality of parameters that are tied to a shared plurality of parameters.

At 404, the computing system can perform a first plurality of training iterations with the machine-learned model to adjust one or more parameters of the shared plurality of parameters.

At 406, the computing system can detect, based at least in part on at least one of the first plurality of training iterations, an occurrence of an untying condition.

At 408, the computing system can untie the plurality of parameters of one or more model units of the plurality of model units from the shared plurality of parameters.

At 410, the computing system can perform a second plurality of training iterations with the machine-learned model to adjust one or more parameters of each of the one or more model units independent of the shared plurality of parameters.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for reducing computational costs of training a machine-learned model, comprising:
obtaining, by a computing system comprising one or more computing devices, a machine-learned model comprising a plurality of model units, wherein each of the plurality of model units comprise a plurality of parameters that are tied to a shared plurality of parameters;
performing, by the computing system, a first plurality of training iterations with the machine-learned model to adjust one or more parameters of the shared plurality of parameters;
detecting, by the computing system based at least in part on at least one of the first plurality of training iterations, an occurrence of an untying condition;
untying, by the computing system, the plurality of parameters of one or more model units of the plurality of model units from the shared plurality of parameters; and
performing, by the computing system, a second plurality of training iterations with the machine-learned model to adjust one or more parameters of each of the one or more model units independent of the shared plurality of parameters.

2. The computer-implemented method of claim 1, wherein:
the machine-learned model comprises two model groups respectively comprising a first subset of model units and a second subset of model units of the plurality of model units, wherein the parameters of each of the first subset of model units is tied to a shared plurality of first group parameters and the parameters of each of the second subset of model units is tied to a shared plurality of second group parameters;
untying the plurality of parameters of the one or more model units comprises untying, by the computing system, the parameters of the first subset of model units from the shared plurality of first group parameters associated with the first subset of model units; and
performing the second plurality of training iterations comprises performing, by the computing system, the second plurality of training iterations with the machine-learned model to adjust one or more parameters of at least one of the first subset of model units independent of the shared plurality of first group parameters and the shared plurality of second group parameters.

3. The computer-implemented method of claim 2, wherein the method further comprises:
detecting, by the computing system based at least in part on at least one of the second plurality of training iterations, an occurrence of a second untying condition different than the untying condition;
untying, by the computing system, the parameters of the second subset of model units from the shared plurality of second group parameters associated with the second subset of model units; and
performing, by the computing system, a third plurality of training iterations with the machine-learned model to adjust one or more parameters of at least one of the second subset of model units independent of the shared plurality of first group parameters and the shared plurality of second group parameters.

4. The computer-implemented method claim 1, wherein performing, by the computing system, the second plurality of training iterations further adjusts one or more of the shared plurality of parameters.

5. The computer-implemented method claim 1, wherein determining the occurrence of the untying condition comprises evaluating, by the computing system, one or more gradient statistics associated with at least one of the first plurality of training iterations.

6. The computer-implemented method claim 1, wherein determining the occurrence of the untying condition comprises determining, by the computing system, that the first plurality of training iterations exceeds a threshold number of training iterations.

7. The computer-implemented method claim 1, wherein each model unit is adjacent to another model unit of the plurality of model units.

8. The computer-implemented method of claim 7, wherein determining the occurrence of the untying condition comprises evaluating, by the computing system, a correlation between gradients of at least two adjacent model units of the plurality of model units.

9. The computer-implemented method claim 1, wherein each of the plurality of model units shares a model unit architecture.

10. The computer-implemented method claim 1, wherein the model unit architecture comprises a sequence of model layers.

11. A computing system for reducing computational costs of training a machine-learned model, comprising:
one or more processors;
one or more tangible, non-transitory computer readable media storing computer-readable instructions that when executed by the one or more processors cause the one or more processors to perform operations, the operations comprising:
obtaining a machine-learned model comprising a plurality of model units, wherein each of the plurality of model units comprise a plurality of parameters that are tied to a shared plurality of parameters;
performing a first plurality of training iterations with the machine-learned model to adjust one or more parameters of the shared plurality of parameters;
detecting, based at least in part on at least one of the first plurality of training iterations, an occurrence of an untying condition;
untying the plurality of parameters of one or more model units of the plurality of model units from the shared plurality of parameters; and
performing a second plurality of training iterations with the machine-learned model to adjust one or more parameters of each of the one or more model units independent of the shared plurality of parameters.

12. The computing system of claim 11, wherein:
the machine-learned model comprises two model groups respectively comprising a first subset and a second subset of model units of the plurality of model units, wherein the parameters of each of the first subset of model units is tied to a shared plurality of first group parameters and the parameters of each of the second subset of model units is tied to a shared plurality of second group parameters;
untying the plurality of parameters of the one or more model units comprises untying the parameters of the first subset of model units from the shared plurality of first group parameters associated with the first model group; and
performing the second plurality of training iterations comprises performing the second plurality of training iterations with the machine-learned model to adjust one or more parameters of at least one of the first subset of model units independent of the shared plurality of first group parameters and the shared plurality of second group parameters.

13. The computing system of claim 12, wherein the operations further comprise:
detecting, based at least in part on at least one of the second plurality of training iterations, an occurrence of a second untying condition different than the first untying condition;
untying the parameters of the second subset of model units from the shared plurality of second group parameters associated with the second group; and
performing a third plurality of training iterations with the machine-learned model to adjust one or more parameters of at least one of the second subset of model units independent of the shared plurality of first group parameters and the shared plurality of second group parameters.

14. The computing system of claim 11, wherein performing the second plurality of training iterations further adjusts one or more of the shared plurality of parameters.

15. The computing system of claim 11, wherein determining the occurrence of the untying condition comprises evaluating one or more gradient statistics associated with the at least one first training iterations.

16. The computing system of claim 11, wherein determining the occurrence of the untying condition comprises determining that the first plurality of training iterations exceeds a threshold number of training iterations.

17. The computing system of claim 11, wherein each model unit is adjacent to another model unit of the plurality of model units.

18. The computing system of claim 17, wherein determining the occurrence of the untying condition comprises evaluating a correlation between gradients of at least two adjacent model units of the plurality of model units.

19. One or more tangible, non-transitory computer readable media storing computer-readable instructions that when executed by one or more processors cause the one or more processors to perform operations, the operations comprising:
obtaining a machine-learned model comprising a plurality of model units, wherein each of the plurality of model units comprise a plurality of parameters that are tied to a shared plurality of parameters;
performing a first plurality of training iterations with the machine-learned model to adjust one or more parameters of the shared plurality of parameters;
detecting, based at least in part on at least one of the first plurality of training iterations, an occurrence of an untying condition;
untying the plurality of parameters of one or more model units from the shared plurality of parameters; and
performing a second plurality of training iterations with the machine-learned model to adjust one or more parameters of each of the one or more model units independent of the shared plurality of parameters.

20. The one or more tangible, non-transitory media of claim 19, wherein:
the machine-learned model comprises two model groups respectively comprising a first subset and a second subset of model units of the plurality of model units, wherein the parameters of each of the first subset of model units is tied to a shared plurality of first group parameters and the parameters of each of the second subset of model units is tied to a shared plurality of second group parameters;
untying the plurality of parameters of the one or more model units comprises untying the parameters of the first subset of model units from the shared plurality of first group parameters associated with the first model group; and
performing the second plurality of training iterations comprises performing the second plurality of training iterations with the machine-learned model to adjust one or more parameters of at least one of the first subset of model units independent of the shared plurality of first group parameters and the shared plurality of second group parameters.
